(19) United States
(12) Patent Application Publication
(10) Pub. No.: US 2012/0131608 A1
(43) Pub. Date: May 24, 2012

(54) Remote Healthcare Services Over Internet Protocol Television

(75) Inventors: Jungsub Byun, Foster City, CA (US); Sun-Uk Park, Union City, CA (US); Stephen A. Sposato, Lafayette, CA (US)

(73) Assignee: AT&T INTELLECTUAL PROPERTY I, L.P., Reno, NV (US)

(21) Appl. No.: 12/950,326

(22) Filed: Nov. 19, 2010

(51) Int. Cl. H04N 7/025; H04N 5/445; H04N 7/173

(52) U.S. Cl. 725/34; 725/109; 725/61; 725/40

(57) ABSTRACT

A particular method includes communicating a media stream in response to receiving a channel change request (e.g., a request to view an interactive health channel) from a first device associated with a patient. The media stream is received from a second device associated with a healthcare provider and is communicated to the first device via an internet protocol television (IPTV) network. The method further includes communicating patient data received from the first device associated with the patient to the second device associated with the healthcare provider via the IPTV network.

### FIELD OF THE DISCLOSURE

The present disclosure is generally related to remote healthcare.

### BACKGROUND

Remote healthcare services may allow patients and healthcare providers to interact without being located at the same physical location. Further, electronic diagnostic equipment at a patient location may provide additional information to a remote healthcare provider.

### BRIEF DESCRIPTION OF THE DRAWINGS

FIG. 1 is a block diagram of a particular embodiment of a remote healthcare system;

FIG. 2 is a diagram of a first particular embodiment of a user interface associated with a remote healthcare system;

FIG. 3 is a diagram of a second particular embodiment of a user interface associated with a remote healthcare system;

FIG. 4 is a flow chart of a first particular embodiment of a remote healthcare method;

FIG. 5 is a flow chart of a second particular embodiment of a remote healthcare method; and

FIG. 6 is an illustration of an illustrative embodiment of a general computer system.

### DETAILED DESCRIPTION

In a particular embodiment, a method includes communicating a media stream in response to receiving a channel change request (e.g., a request to view an interactive health channel) from a first device associated with a patient. The media stream is received from a second device associated with a healthcare provider and is communicated to the first device via an internet protocol television (IPTV) network. The method further includes communicating patient data received from the first device associated with the patient to the second device associated with the healthcare provider via the IPTV network.

In another particular embodiment, a system includes a processor and a memory accessible to the processor. The memory includes instructions that, when executed by the processor, cause the processor to communicate a media stream in response to receiving a channel change request from a first device associated with a patient. The media stream is received from a second device associated with a healthcare provider and is communicated to the first device via an IPTV network. Patient data received from the first device associated with the patient is communicated to the second device associated with the healthcare provider via the IPTV network.

In another particular embodiment, a non-transitory computer-readable medium is disclosed that includes processor executable instructions. In response to receiving a channel change request from a first device located at a customer premises of a patient, a media stream that is received from a second device associated with a healthcare provider is communicated to the first device via an IPTV network. Patient data received from the first device located at the customer premises of the patient is communicated to the second device associated with the healthcare provider via the IPTV network. The patient data may include health information that is obtained via a plurality of health check sensors that are located at the customer premises of the patient.

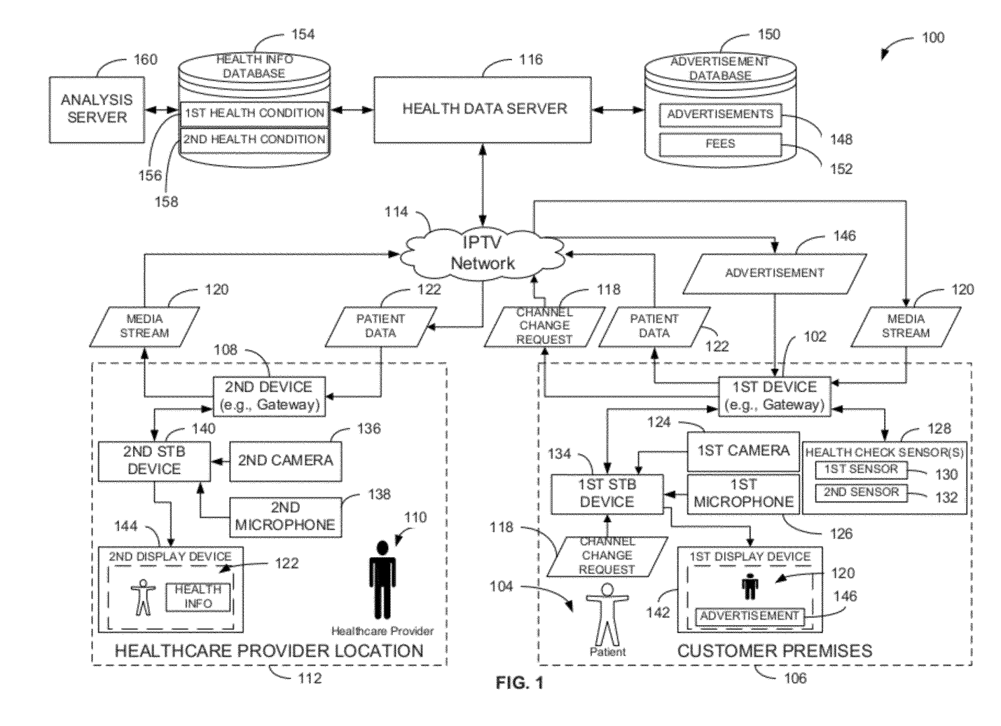

Referring to FIG. 1, a particular embodiment of a remote healthcare system is illustrated and is designated 100. The system 100 includes a first device 102 that is associated with a patient 104 (e.g., located at a customer premises 106 of the patient 104) and a second device 108 associated with a healthcare provider 110 (e.g., remotely located at a healthcare provider location 112). The first device 102 and the second device 108 are communicatively coupled to an IPTV network 114. The system 100 includes a health data server 116 that is communicatively coupled to the first device 102 and to the second device 108 via the IPTV network 114.

The health data server 116 is configured to receive a channel change request 118 from the first device 102 associated with the patient 104 via the IPTV network 114. The health data server 116 is further configured to receive a media stream 120 from the second device 108 associated with the healthcare provider 110 and to receive patient data 122 via the IPTV network 114. In response to receiving the channel change request 118, the health data server 116 is configured to communicate the media stream 120 received from the second device 108 to the first device 102 via the IPTV network 114. The health data server 116 is further configured to communicate the patient data 122 to the second device 108 via the IPTV network 114. In one embodiment, the health data server 116 may be configured to communicate the patient data 122 to a third device (not shown) via the IPTV network 114. For example, the third device may be an emergency healthcare service provider or a friend or family member selected by the patient 104. The health data server 116 may be further configured to communicate the media stream 120 to the first device 102 and to the third device via the IPTV network 114 at substantially the same time.

In a particular embodiment, the patient data 122 includes video data, audio data, or other data associated with the customer premises 106 (e.g., ambient temperature or humidity at the customer premises 106). For example, the patient data 122 may include video (or one or more still images) of the patient 104 captured via a first camera 124, audio captured via a first microphone 126, health information from one or more health check sensors 128, or a combination thereof. In the embodiment illustrated in FIG. 1, the one or more health check sensors 128 include a first sensor 130 and a second sensor 132. As illustrative examples, the health check sensors 128 may include a device for measuring cholesterol levels, a blood pressure device for measuring blood pressure, a weight scale for measuring weight, a blood glucose monitor for measuring blood glucose level, a spirometer for measuring breathing capacity, an electrocardiograph for generating an electrocardiogram, a pulse oximeter for measuring oxygen level in the blood, and an electronic stethoscope for collecting heart, lung and bowel sounds, among other alternatives. Alternatively, any number of health check sensors 128 may be located at the customer premises 106. In the embodiment illustrated in FIG. 1, a first set-top box (STB) device 134 receives data from the first camera 124 and the first microphone 126, and the first device 102 (e.g., a residential gateway) receives the health information from the one or more health check sensors 128 and information from the first STB device 134.

In a particular embodiment, the media stream 120 associated with the healthcare provider 110 includes video data, audio data, or other data. For example, the media stream 120 may include video (or one or more still images) of the healthcare provider 110 captured via a second camera 136, audio captured via a second microphone 138, or a combination thereof. In the embodiment illustrated in FIG. 1, a second STB device 140 receives data from the second camera 136 and the second microphone 138, and the second device 108 (e.g., a gateway associated with the healthcare provider location 112) receives information from the second STB device 140. A first display device 142 (e.g., a television) located at the customer premises 106 may display the media stream 120, and a second display device 144 (e.g., a television) located at the healthcare provider location 112 may display the patient data 122.

In a particular embodiment, the health data server 116 may be configured to select an advertisement 146 that is targeted to the patient 104 based at least in part on the received patient data 122. The health data server 116 may also be configured to determine a geographical location of the patient 104. In this case, the advertisement 146 may be selected based at least in part on the received patient data 122 and the geographical location of the patient 104. The advertisement 146 may be selected from a plurality of advertisements 148 stored at an advertisement database 150. In one embodiment, one or more fees 152 may be associated with a particular advertisement of the plurality of advertisements 148. The health data server 116 may be configured to determine a fee 152 to charge an advertiser to communicate the advertisement 146 to the patient 104.

The health data server 116 may be configured to communicate the selected advertisement 146 to the first device 102 via the IPTV network 114. The advertisement 146 may be displayed at the first display device 142 of the patient 104. In one embodiment, the advertisement 146 may be associated with video on demand (VoD) content, and the health data server 116 may be configured to receive information indicating a selection of the advertisement 146 and to communicate the VoD content associated with the advertisement 146 to the first device 102 via the IPTV network 114 in response to the selection of the advertisement 146.

In the embodiment illustrated in FIG. 1, the system 100 includes a health information database 154. In a particular embodiment, the health data server 116 may receive health information obtained via the plurality of health check sensors 128. For example, the received health information may include at least first health information obtained via the first health check sensor 130 and second health information obtained via the second health check sensor 132. The health data server 116 may be configured to query the health information database 154 to identify a health condition that is associated with the first health information and the second health information. To illustrate, a first health condition 156 may be associated with a first set of health data, while a second health condition 158 may be associated with a second set of health data. In one embodiment, the advertisement 146 may be further selected based on the identified health condition. An analysis server 160 may be configured to communicate with the health information database 154 in order to analyze patient data received from multiple patients via the IPTV network 114.

In operation, the patient 104 may communicate the channel change request 118 to the first STB device 134. For example, the patient 104 may transmit the channel change request 118 to the first STB device 134 via a remote control (not shown). In one embodiment, the requested channel is an interactive healthcare channel. The channel change request 118 may be communicated from the first STB device 134 to the health data server 116 via the first device 102 (e.g., the residential gateway). The first device 102 may communicate the channel change request 118 to the health data server 116 via the IPTV network 114. In response to receiving the channel change request 118, the health data server 116 may establish a remote healthcare session between the patient 104 and the healthcare provider 110.

The remote healthcare session may enable the patient 104 and the healthcare provider 110 to interact despite being remotely located. Further, the patient data 122 provided to the healthcare provider 110 may include health information captured via the one or more health check sensors 128 that are located at the customer premises 106 of the patient 104. The additional health information may aid the healthcare provider 110 in diagnosing the patient 104.

With access to the patient data 122, the selected advertisement 146 may be more effectively targeted to the patient 104. For example, health information obtained via the one or more health check sensors 128 may enable the health data server 116 to identify the first health condition 156 or the second health condition 158 as applicable to the patient 104. To illustrate, a scientific study may identify an increased risk of stroke for patients with high cholesterol and high blood pressure. Further, the geographical location of the patient 104 may provide additional information to more effectively target the advertisement 146. For example, if the first health check sensor 130 measures high blood pressure, an advertisement associated with a local cardiologist may be selected. As another example, high allergen levels or high pollution levels associated with the particular geographical location may be associated with asthma. If the first health check sensor 130 is a spirometer that measures airway constriction, the selected advertisement 146 may be associated with a local allergy clinic.

The advertisement 146 displayed to the patient 104 via the first display device 142 may be selectable (e.g., associated with VoD content). In this case, an advertiser may be charged a pay-per-click fee when the advertisement 146 is selected by the patient 104. Alternatively, the advertiser may be charged a pay-per-impression fee when the advertisement 146 is not selected by the patient 104. The pay-per-click fee may be greater than the pay-per-impression fee. Further, the pay-per-click fee may depend on whether the entire VoD content stream was displayed. For example, the patient 104 may view a portion or all of the VoD content stream, and the fee 152 may vary accordingly.

Thus, the system 100 of FIG. 1 may enable the patient 104 and the healthcare provider 110 to establish a remote healthcare session via the IPTV network 114. An interactive healthcare channel and a common network (e.g. the IPTV network 114) may enable the patient 104 and the healthcare provider 110 to more easily establish a remote healthcare session. Further, delivery of the targeted advertisement 146 to the patient 104 may provide an additional source of revenue to the IPTV service provider and may reduce costs that are associated with facilitating the remote healthcare session. In one embodiment, the interactive healthcare channel may be advertisement-supported and available to the patient 104 at a reduced charge without additional charge.

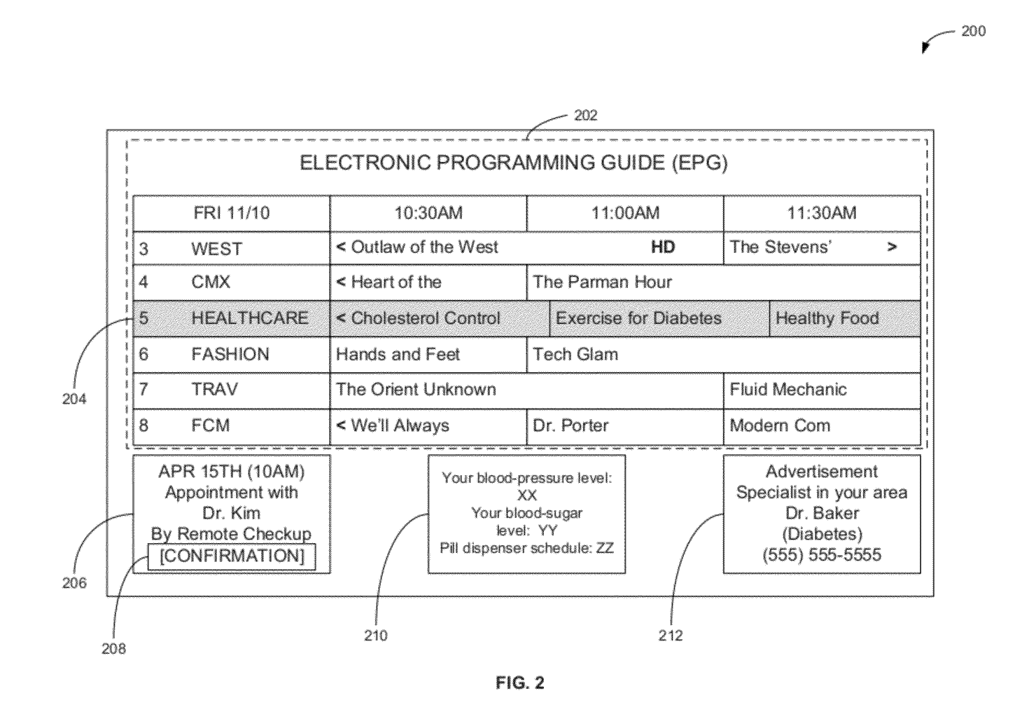

Referring to FIG. 2, a particular embodiment of a user interface is illustrated and is designated 200. The user interface 200 may be displayed via the first display device 142 of FIG. 1 and may include an electronic programming guide (EPG) 202 that may enable a user (e.g., the patient 104 of FIG. 1) to select an interactive healthcare channel 204. The user interface 200 may enable communication of a reminder 206 of an appointment with a healthcare provider (e.g., the healthcare provider 110 of FIG. 1) and a selectable option 208 to confirm the appointment. Further, the user interface 200 may enable the patient to view health information 210 collected via one or more health check sensors (e.g., the health check sensors 128 of FIG. 1) and to view an advertisement 212 that may be targeted to the patient (e.g., the advertisement 146 of FIG. 1).

A remote healthcare session may be established in response to receiving a channel change request from the patient. To illustrate, the patient may select the interactive healthcare channel 204 via the EPG 202 of FIG. 2. Alternatively, the patient may select the interactive healthcare channel 204 by inputting the channel number (e.g., channel 5) associated with the interactive healthcare channel 204 or by otherwise selecting the channel number (e.g., via channel up/down buttons of a remote control or of the first STB device 134).

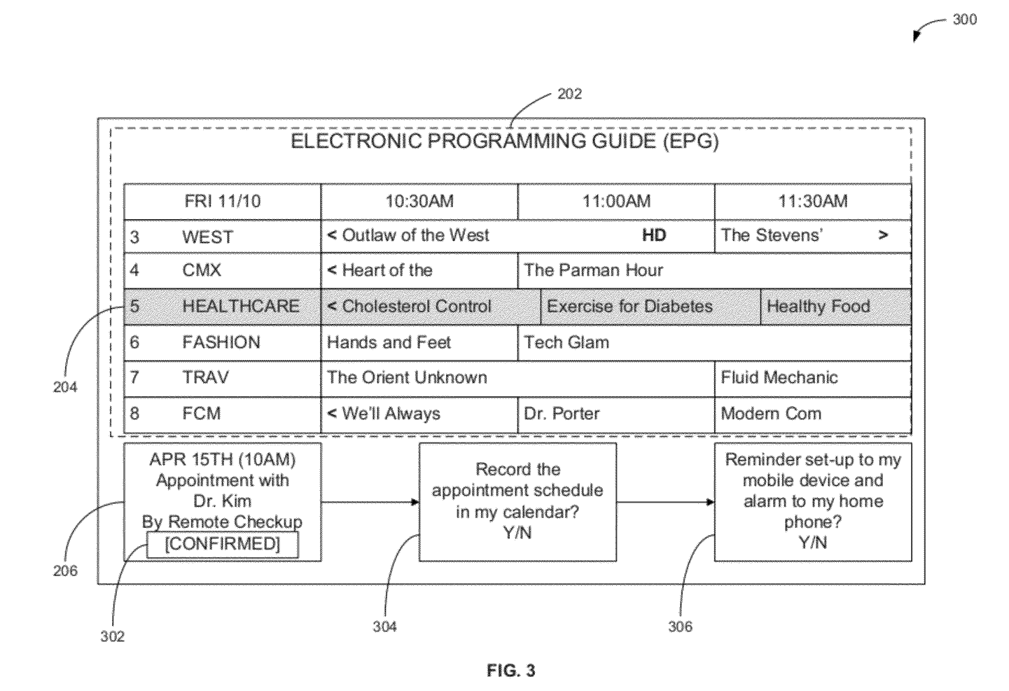

Referring to FIG. 3, another particular embodiment of a user interface is illustrated and is designated 300. The user interface 300 of FIG. 3 may be displayed in response to selection of the selectable option 208 of FIG. 2.

In one embodiment, in response to selection of the selectable option 208, an appointment confirmation message may be communicated to the healthcare provider (e.g. the healthcare provider 110). Further, an appointment confirmation indicator 302 may be displayed to indicate to the patient that the appointment has been confirmed. After the appointment has been confirmed, a first message 304 may be provided to the patient that may enable the patient to record the appointment schedule in a calendar. For example, the calendar may be stored at the first STB device 134 of the patient 104 of FIG. 1. Further, a second message 306 may be provided to the patient that may enable the patient to set up a reminder of the confirmed appointment. For example, the reminder may be provided to a mobile device (e.g., a mobile telephone) of the patient or to another device (e.g., to a home phone of the patient).

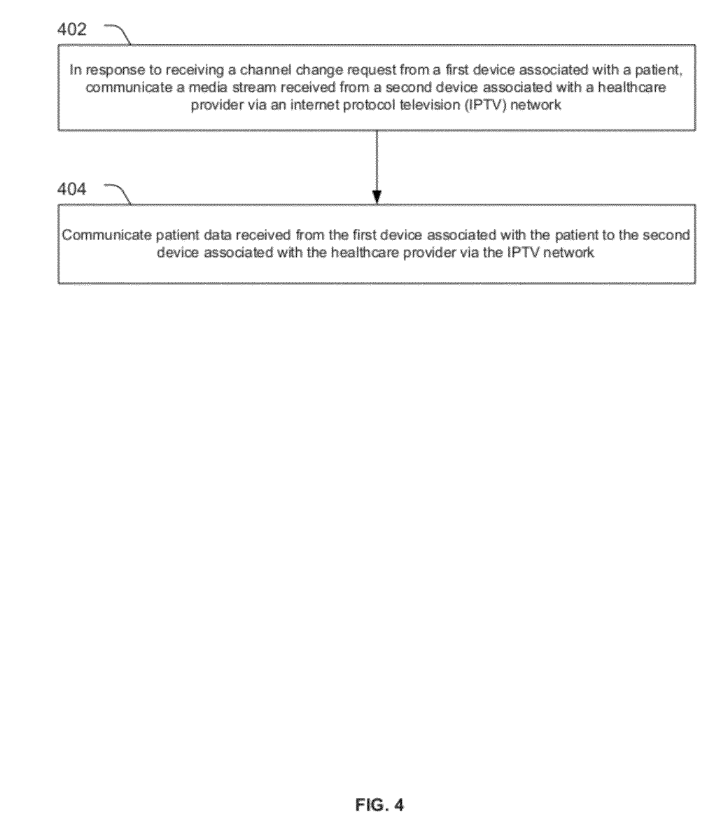

Referring to FIG. 4, a particular embodiment of a remote healthcare method is illustrated. The method includes communicating a media stream in response to receiving a channel change request from a first device associated with a patient, at 402. The media stream is received from a second device associated with a healthcare provider via an IPTV network and is communicated to the first device via the IPTV network. For example, in FIG. 1, the channel change request 118 may be received at the first STB device 134 (e.g., via remote control) and may be communicated from the first device 102 (e.g., a residential gateway) to the health data server 116 via the IPTV network 114. The health data server 116 may receive the media stream 120 from the healthcare provider 110 via the IPTV network 114 and communicate the media stream 120 to the first device 102 via the IPTV network 114 in response to receiving the channel change request 118.

The method includes communicating patient data received from the first device associated with the patient to the second device associated with the healthcare provider via the IPTV network, at 404. For example, in FIG. 1, the health data server 116 may communicate the patient data 122 received from the first device 102 to the second device 108 associated with the healthcare provider 110 via the IPTV network 114.

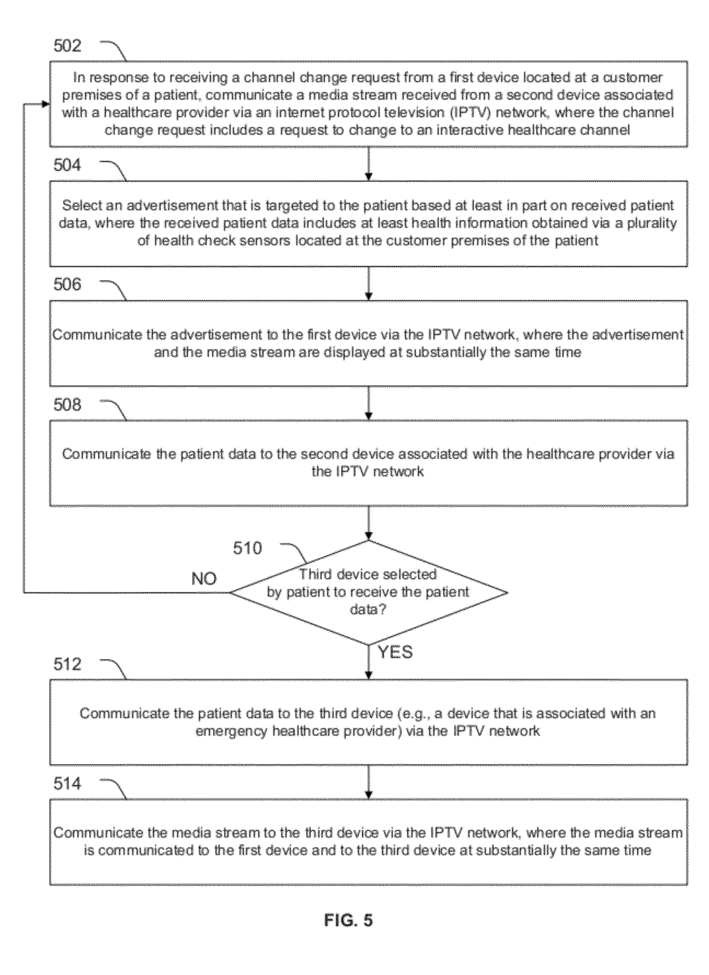

Referring to FIG. 5, another particular embodiment of a remote healthcare method is illustrated. The method includes communicating a media stream in response to receiving a channel change request from a first device associated with a patient, at 502. The media stream is received from a second device associated with a healthcare provider via an IPTV network and is communicated to the first device via the IPTV network.

In the particular embodiment illustrated in FIG. 5, the channel change request includes a request to change to an interactive healthcare channel. For example, in FIG. 1, the patient 104 may transmit the channel change request 118 to the first STB device 134 via a remote control. To illustrate, the patient 104 may select the interactive healthcare channel 204 via the EPG 202 of FIG. 2.

The method may include selecting an advertisement that is targeted to the patient based at least in part on received patient data, at 504. In the embodiment illustrated in FIG. 5, the received patient data includes at least health information obtained via a plurality of health check sensors located at the customer premises of the patient. For example, the health data server 116 of FIG. 1 may select the advertisement 146 from the advertisement database 148 based at least in part on the patient data 122 (that includes health information obtained via the plurality of health check sensors 128).

The method may include communicating the advertisement to the first device via the IPTV network, at 506. The advertisement and the media stream may be displayed at substantially the same time. For example, the health data server 116 of FIG. 1 may communicate the advertisement 146 to the first device 102 (e.g., a residential gateway associated with the customer premises 106) via the IPTV network 114. The advertisement 146 may be displayed at the first display device 142 at substantially the same time as the media stream 120.

The method includes communicating the patient data to the second device associated with the healthcare provider via the IPTV network, at 508. For example, the health data server 116 of FIG. 1 may communicate the patient data 122 to the second device 108 (e.g., a gateway at the healthcare provider location 112). The patient data 122 may be displayed at the second display device 144.

In the embodiment illustrated in FIG. 5, the method includes determining whether a third device is selected (e.g., by the patient) to receive the patient data, at 510. When a third device is selected to receive the patient data, the method includes communicating the patient data to the third device via the IPTV network (e.g., the IPTV network 114 of FIG. 1). For example, the third device may include a device that is associated with an emergency healthcare provider. Alternatively, the third device may be a device associated with a friend, family member, or another third party designated by the patient to receive the patient data. In one embodiment, the designated third party may view the patient data by selecting an interactive healthcare channel (e.g., the interactive healthcare channel 204 of FIGS. 2 and 3).

In the embodiment illustrated in FIG. 5, the method also includes communicating the media stream to the third device via the IPTV network, at 514. The media stream may be communicated to the first device and to the third device at substantially the same time. In this case, the designated third party may be able to participate in a remote healthcare session conducted between the patient and the healthcare provider. For example, the patient data may be displayed to the designated third party at a first portion of a display, while the media stream associated with the healthcare provider may be displayed at a second portion of the display. In a particular embodiment, the designated third party may also provide information (e.g., a multimedia stream) to at least one of the healthcare provider and the patient. In this case, the media stream associated with the healthcare provider may be displayed to the patient at a first portion of a display while the media stream associated with the designated third party may be displayed via a second portion of the display. Further, the media stream associated with the designated third party may be displayed to the healthcare provider at a first portion of a display while the patient data may be displayed via a second portion of the display. Thus, the remote healthcare session may include multiple parties (e.g., the patient, the healthcare provider, and one or more additional parties).

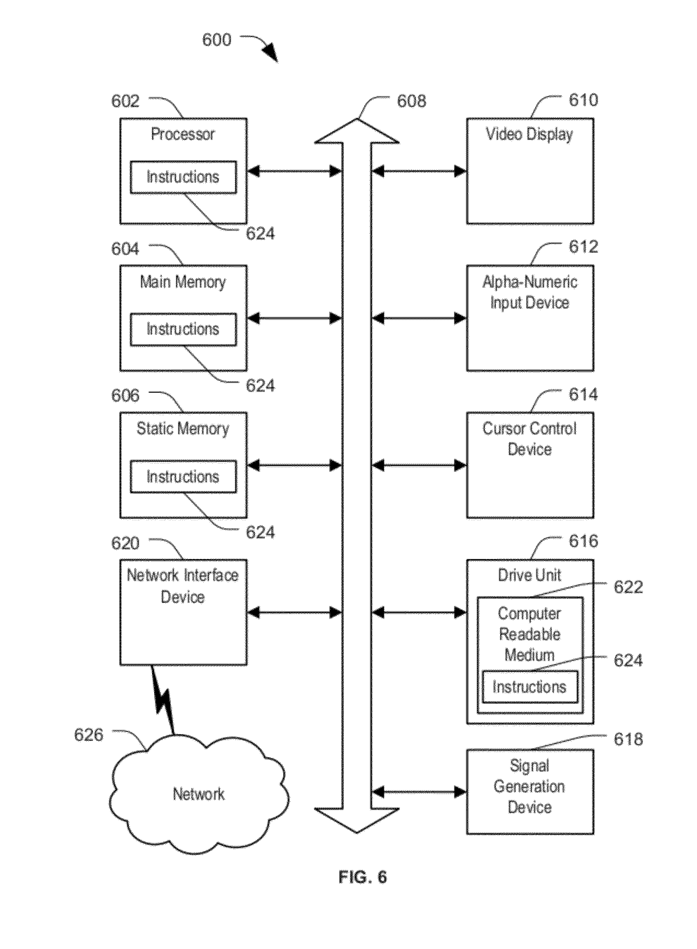

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices. For example, the general computer system 600 may include or be included within any one or more of the end-user communication devices, servers, repositories, and network equipment illustrated in FIG. 1.

In a networked deployment, the computer system 600 may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606, that can communicate with each other via a bus 608. As shown, the computer system 600 may further include a video display unit 610, such as a liquid crystal display (LCD), an organic light emitting diode (OLED), a flat panel display, or a solid state display. Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any non-transitory medium that is capable of storing or encoding a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device. Accordingly, the disclosure is considered to include any one or more of a computer-readable medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the disclosure. Thus, to the maximum extent allowed by law, the scope of the disclosure is to be determined by the broadest permissible interpretation of the following claims and their equivalents, and shall not be restricted or limited by the foregoing detailed description.

What is claimed is:

1. A method, comprising:
in response to receiving a channel change request from a first device associated with a patient, communicating a media stream received from a second device associated with a healthcare provider via an internet protocol television (IPTV) network; and
communicating patient data received from the first device associated with the patient to the second device associated with the healthcare provider via the IPTV network.

2. The method of claim 1, wherein the channel change request includes a request to view an interactive healthcare channel.

3. The method of claim 1, further comprising:
selecting an advertisement that is targeted to the patient based at least in part on the received patient data; and
communicating the advertisement to the first device via the IPTV network.

4. The method of claim 3, wherein the advertisement and the media stream are displayed at substantially the same time.

5. The method of claim 3, wherein the advertisement is associated with video on demand (VoD) content that is displayed upon selection by the patient.

6. The method of claim 3, wherein the patient data includes first health information obtained via a first health check sensor, and wherein the advertisement is further selected based on the first health information.

7. The method of claim 6, wherein the patient data further includes second health information obtained via a second health check sensor, and wherein the advertisement is further selected based on the second health information.

8. The method of claim 3, wherein the advertisement is further selected based on a geographical location of the patient.

9. The method of claim 1, further comprising communicating the patient data to a third device via the IPTV network, wherein the third device is not associated with the patient and is not associated with the healthcare provider.

10. The method of claim 9, wherein the third device is selected by the patient.

11. The method of claim 9, wherein the third device is associated with an emergency healthcare service provider.

12. The method of claim 9, further comprising communicating the media stream to the third device via the IPTV network, wherein the media stream is communicated to the first device and to the third device at substantially the same time.

13. A system comprising:
a processor; and
memory accessible to the processor, the memory comprising instructions that, when executed by the processor, cause the processor to:
in response to receiving a channel change request from a first device associated with a patient, communicate a media stream received from a second device associated with a healthcare provider via an internet protocol television (IPTV) network; and
communicate patient data received from the first device associated with the patient to the second device associated with the healthcare provider via the IPTV network.

14. The system of claim 13, wherein the memory further comprises instructions that, when executed by the processor, cause the processor to:
select an advertisement from an advertisement database, wherein the advertisement is targeted to the patient based at least in part on the received patient data, and wherein the advertisement is associated with video on demand (VoD) content;
communicate the advertisement to the first device via the IPTV network;
receive information indicating a selection of the advertisement; and
communicate the VoD content associated with the advertisement to the first device via the IPTV network in response to the selection of the advertisement.

15. The system of claim 14, wherein the memory further comprises instructions that, when executed by the processor, cause the processor to:
receive health information obtained via a plurality of health check sensors, wherein the advertisement is further selected based on the health information.

16. The system of claim 14, wherein the memory further comprises instructions that, when executed by the processor, cause the processor to:
receive health information obtained via a plurality of health check sensors, wherein the received health information includes at least first health information obtained via a first health check sensor and second health information obtained via a second health check sensor; and
query a health information database to identify a health condition that is associated with the first health information and the second health information,
wherein the advertisement is further selected based on the identified health condition.

17. The system of claim 13, wherein the memory further comprises instructions that, when executed by the processor, cause the processor to:
communicate a reminder of an appointment with the healthcare provider to the first device via the IPTV network, wherein the reminder of the appointment is displayed via an electronic programming guide (EPG), and wherein the reminder includes a selectable option to confirm the appointment; and
in response to selection of the selectable option, communicate an appointment confirmation message to the healthcare provider via the IPTV network.

18. A non-transitory computer-readable medium comprising instructions that, when executed by a processor, cause the processor to:
in response to receiving a channel change request from a first device located at a customer premises of a patient, communicate a media stream received from a second device associated with a healthcare provider via an internet protocol television (IPTV) network; and
communicate patient data received from the first device located at the customer premises of the patient to the second device associated with the healthcare provider via the IPTV network, wherein the patient data includes health information obtained via a plurality of health check sensors that are located at the customer premises of the patient.

19. The non-transitory computer-readable medium of claim 18, further comprising instructions that, when executed by the processor, cause the processor to:
determine a geographical location of the patient;
select an advertisement from an advertisement database, wherein the advertisement is targeted to the patient based on at least the received patient data and the geographical location of the patient; and
communicate the advertisement to the first device via the IPTV network.

20. The non-transitory computer-readable medium of claim 18, further comprising instructions that, when executed by the processor, cause the processor to:
select an advertisement from an advertisement database, wherein the advertisement is targeted to the patient based on at least the received patient data;
communicate the advertisement to the first device via the IPTV network; and
determine a fee to charge an advertiser to communicate the advertisement to the patient,
wherein the fee includes a pay-per-click fee when the advertisement is selected by the patient, wherein the fee includes a pay-per-impression fee when the advertisement is not selected by the patient, and wherein the pay-per-click fee is greater than the pay-per-impression fee.
